(19) United States
(12) Patent Application Publication
(10) Pub. No.: US 2017/0002214 A1
(43) Pub. Date: Jan. 5, 2017

(54) PROCESS FOR COATING ELECTROCONDUCTIVE SUBSTRATES

(71) Applicant: BASF COATINGS GMBH, Münster (DE)

(72) Inventors: Franz-Adolf CZIKA, Neuss (DE); Klaus LEPA, Troisdorf (DE); Kristof WAPNER, Duesseldorf (DE)

(73) Assignee: BASF COATINGS GMBH, Muenster (DE)

(21) Appl. No.: 15/105,472

(22) PCT Filed: Dec. 19, 2013
(86) PCT No.: PCT/EP2013/077457

§ 371 Date: Jun. 16, 2016

(51) Int. Cl. C09D 5/44; C25D 7/00; C25D 9/02

(52) U.S. Cl. CPC C09D 5/4488; C09D 5/4484; C09D 5/4438; C25D 9/02; C25D 7/00

(57) ABSTRACT

The present invention relates to a process for the at least two-stage coating of an electrically conductive substrate, the at least two-stage coating being carried out in a single dip-coating bath, the dip-coating bath comprising a coating material composition which comprises at least one cathodically depositable film-forming polymer and also an anodically depositable component, the anodically depositable component comprising anions of at least one phosphorus oxoacid; in a first stage, the electrically conductive substrate for coating is connected as anode in said dip-coating bath, and in a subsequent stage the now precoated substrate is connected as cathode in said dip-coating bath. The invention further relates to a substrate coated by the process of the invention.

The present invention relates to a process for the multistage coating of electrically conductive substrates in an electrocoating bath. The invention further relates to substrates coated by the process of the invention.

Processes for electrocoating are used especially in the automotive finishing sector. A fundamental prerequisite allowing the electrically conductive substrates—such as steels, galvanized steels, or aluminum sheets, for example—to be coated in high quality by electrocoating is pretreatment of the substrates. One of the aims of pretreatment is to ensure effective adhesion of all subsequent coating films on the metallic substrate. Absent pretreatment, moreover, the metallic substrate is not guaranteed adequate corrosion protection by the electrocoat.

Substrate pretreatment generally encompasses diverse washing, degreasing, and rinsing steps, before the metal surface is activated and then phosphatized. In the context of phosphatizing, another term used is the application of a conversion coat. Such finely crystalline phosphate coats, because of the surfaces of the phosphate crystals, enlarge the surface area to be coated, thus permitting the generation of more points of adhesion and anchoring between metal surface and coating film. Furthermore, corrosion-inhibiting substances are applied, such as compounds of zinc, of manganese or of calcium. In a conventional process, before the substrate thus pretreated is supplied to an electrocoating bath, it is rinsed with fully demineralized water, in order to prevent inorganic chemicals being carried into the electrocoating bath.

Since the mid-1970s, particularly in the area of automobile finishing, cathodic electrodeposition coating (cathodic e-coat) has increasingly been carried out in order to coat electrically conductive substrates. Electrocoat materials are aqueous coating materials which in addition to film-formers and additives contain some solvent and also pigments and extenders. The epoxy resin-based film-formers that are used most often here provide particularly good corrosion protection coats. The metal substrate is immersed into the dispersion of the dipping varnish, stabilized by cationic charges on the film-former, and is connected as the cathode in the case of cathodic e-coat. At the cathode, water accepts electrons and is electrolyzed with formation of hydrogen and of hydroxide ions, resulting in an increase in pH. This in turn gives rise to coagulation of the particles in the dispersion, forming a coagulated paint film.

Disadvantages with the conventional process, in which first of all there is a pretreatment such as a dip-phosphatizing procedure, for example, followed by cathodic electrocoating, are the mandatory use of two separate baths and the performance of the obligatory rinsing operations, prior to the transfer of the metallic substrates into the electrocoating bath.

From the standpoint of process economy it would be desirable to be able to carry out at least some of the pretreatment measures in the electrocoating bath itself.

EP 1788051 A1 describes a process in which a resin component is deposited jointly with at least one corrosion-inhibiting component selected from the group of the ions of zirconium, titanium, cobalt, vanadium, tungsten, and molybdenum, and/or their oxymetal ions or fluorometal ions, at a voltage of between 10 to 400 volts. But this does not allow the deposition on the substrate of a continuous metal layer, since part of the metal surface is occupied by the resin deposited at the same time.

In order to reduce this problem, for example, JP 63171898 A describes a coating process in which a substrate is coated first with a heavy metal and thereafter with the film-former, by applying different voltages successively between the substrate and counterelectrode. For instance, in order to deposit the heavy metal film, from the heavy metal salt of an organic or inorganic acid, a voltage of 10 to 30 volts is applied, and a voltage of 40 to 80 volts in order to deposit the polymer film. WO 2006/109862 describes a similar process, the first step of which sees a voltage of less than 50 volts being applied, in order to effect cathodic deposition of a coating comprising a rare earth metal compound, while a second step sees coagulation, likewise cathodically at a voltage of 50 to 450 volts, of a base resin having cationic groups, accompanied by film formation. JP 2007314690 A and JP 2010214283 A as well describe corresponding processes. With these processes as well, however, it is not possible entirely to avoid some of the resin being undesiredly deposited at the low voltage, leading likewise to heterogeneous surface occupancy and poorer properties of adhesion and corrosion protection. At such low voltages, moreover, only low deposition rates can be realized, and this prolongs the treatment time and allows no more than insufficient deposition of the metal component in cavities of the metallic substrate.

U.S. Pat. No. 4,222,837 describes the deposition of metal phosphates by means of a cathodic current. As a result, there is a risk that some of the organic coating material composition will be deposited as well, and hence that the formation of a continuous phosphatizing coat will be inhibited.

In the area of anodic electrocoating (anodic e-coat), U.S. Pat. No. 7,625,476 B1 discloses a process wherein first of all a zirconium compound is deposited cathodically and thereafter a resin which carries anionic groups is deposited anodically, in order to produce industrial coating systems. However, as mentioned earlier, anodic electrocoating has been unable to establish itself in areas where high-quality coating systems are required, as in automotive OEM finishing in particular.

It was an object of the present invention to provide a process which does not have the disadvantages of the prior art. In particular, the process ought to make it possible, from a cathodic electrocoating bath, first to deposit a first corrosion-inhibiting layer, free very largely from organic film-forming polymers and resins, on a metallic substrate, and only in a second step to apply a cationically stabilized polymer or resin to the first layer. The deposition of the two layers ought to take place as evenly as possible. Moreover, the process ought to make it possible to attain high deposition rates. Lastly, the process ought to obviate the need for the separate phosphatizing step customary in the prior art.

The problems stated above have been resolved by provision of a process for the at least two-stage coating of an electrically conductive substrate, the at least two-stage coating being carried out in a single dip-coating bath, the dip-coating bath comprising a coating material composition which comprises at least one cathodically depositable film-forming polymer and also an anodically depositable component, the anodically depositable component comprising anions of at least one phosphorus oxoacid; in a first stage, the electrically conductive substrate for coating is connected as anode in said dip-coating bath, and in a subsequent stage the now precoated substrate is connected as cathode in said dip-coating bath. This process is also referred to hereinafter as process of the invention.

Examples of anions of typical phosphorus oxoacids are anions of phosphoric acid, such as phosphate, hydrogen phosphate, and dihydrogen phosphate ions, anions of phosphorous acid, anions of diphosphoric acid, anions of diphosphorous acid, and anions of linear or cyclic oligophosphoric acids having 3 to 10 phosphorus atoms.

The anion or anions of the phosphorus oxoacids are present in the coating material composition of the dip-coating bath at a concentration preferably of 0.1 to 40 g/l, more preferably 0.2 to 30 g/l. If the concentration is below 0.1 g/l, there is a fall in the corrosion-inhibiting effect. At concentrations above 40 g/l, the stability of the coating material composition may be adversely affected.

With particular preference the phosphorus oxoacids contain no further metals or semimetals. Very preferably, the anions of the phosphorus oxoacids comprise the anodically depositable species alone.

In the context of the invention it is also possible to use combinations of different anodically depositable components.

In one preferred embodiment, besides the obligatory anions of the phosphorus oxoacids to be used, no further anodically depositable metallic compounds, comprising metal-containing ions, are used in the dip-coating bath.

In contrast to the simultaneous deposition of metal ions and binder at a specifically selected voltage, as practiced in the prior art cited above, the process of the invention carries out separate deposition of the substantially inorganic, phosphorus-containing pretreatment coat and of the subsequent polymer coat, owing to the differences in pole connection of the substrate—initially as anode and later as cathode.

The attempt likewise described in the prior art cited above, for separately cathodic deposition without switching the pole connection of the substrate, merely through choice of different voltages, is achieved only conditionally. In relation to the deposition of metal ions, attempts are made to keep the metal surface free from deposited binder for an appropriately long time. Even at extremely low voltages, however, deposition of binder begins, and the deposition of the metal ions is greatly restricted as a result. Because of the profile of the field lines, deposition in the case of geometrically complex substrates is nonuniform and/or time-delayed. Thus, in the processes of the prior art, the outer surfaces are coated first, and deposition in the cavities of the substrate—the automobile body, for example—takes place only in subsequent course.

During the first stage of the process of the invention, the electrically conductive substrate is connected as anode. During this time window, anodically depositable components comprising the anions of the phosphorus oxoacids, and also, optionally, further metal-containing compounds comprising metal-containing ions, are deposited from the cathodic electrocoating bath on the anodically connected substrate. Deposition of the cathodically depositable film-forming polymer or polymers does not take place under these conditions. The procedure of the invention therefore allows very largely uniform deposition of a first, preferably continuous, corrosion-inhibiting coat of the anodically depositable components. In contrast to the two-stage cathodic-cathodic deposition known from the prior art, at different voltages, it is also possible to apply a significantly higher voltage in the case of the deposition according to the invention, which takes place initially only anodically, if there is a desire for high deposition rates and/or for short treatment times.

The anodic current can be connected as a continuous direct current. Furthermore, the anodic current can be connected in the form of voltage profiles, such as voltage ramps or pulsed direct currents.

During the subsequent stage of the process of the invention, the substrate is connected cathodically. In this stage, at least one cathodically depositable film-forming polymer is deposited cathodically from the coating material composition contained in the dip-coating bath.

As a result of the spatial integration of the first-stage deposition of a substantially inorganic, corrosion-inhibiting coat with the subsequent deposition of the cathodically depositable film-forming polymer within one dip-coating bath, there is a great improvement not only from the standpoint of process economics, since unnecessary rinsing operations can be avoided. Additionally, moreover, the procedure of the invention leads to multicoat coatings which in respect of corrosion resistance and adhesion properties are superior to those of the conventional processes.

The anodic deposition (first stage) of the anodically depositable component takes place preferably at a voltage of 1 to 100 volts, very preferably 2 to 50 volts. A typical coating time in this context is 5 to 240 seconds, preferably 5 to 120 seconds, and more preferably 10 to 90 seconds. The deposition voltage may, however, also adopt different values during the deposition time of the first stage, within the stated minimum and maximum values—for example, it may shuttle back and forth or increase in the form of a ramp or steps from the minimum to the maximum deposition voltage. The deposition voltage in the first stage may also be regulated in the form of pulses, with times without current or with a deposition voltage below the minimum between the pulses. The pulse duration may be situated, for example, in the range from 0.1 to 10 seconds. The “period” for the deposition will then be regarded as the total of the periods during which the deposition voltage is within the stated topmost and bottommost values. Ramps and pulses may also be combined with one another.

The cathodic deposition (subsequent stage) of the cathodically depositable film-forming polymer (principal binder) takes place preferably at a voltage of 50 to 500 volts, more preferably 150 to 450 volts, and very preferably 250 to 400 volts. In this case the substrate connected as anode in the first stage now serves as cathode, and the counterelectrode used may now be an as yet uncoated substrate or an anode not serving as substrate. The typical coating time for this stage is 10 to 300 seconds, preferably 30 to 240 seconds. During the coating time, the deposition voltage may be held constant at a defined value over the stated period. The deposition voltage may, however, also adopt different values during the deposition time of the second stage, within the stated minimum and maximum values—for example, it may shuttle back and forth or increase in the form of a ramp or steps from the minimum to the maximum deposition voltage. The deposition voltage in the second stage may also be regulated in the form of pulses, with times without current or with a deposition voltage below the minimum between the pulses. The pulse duration may be situated, for example, in the range from 0.1 to 10 seconds. The “period” for the deposition will then be regarded as the total of the periods during which the deposition voltage is within the stated topmost and bottommost values. Ramps and pulses may also be combined with one another.

Since both stages of the process are carried out in a single electrocoating bath, the pH during both stages of the process is in the acidic range. The typical pH of the electrocoat material is in the range from 4 to 7, more preferably 5 to 6.5 and very preferably 5 to 6.

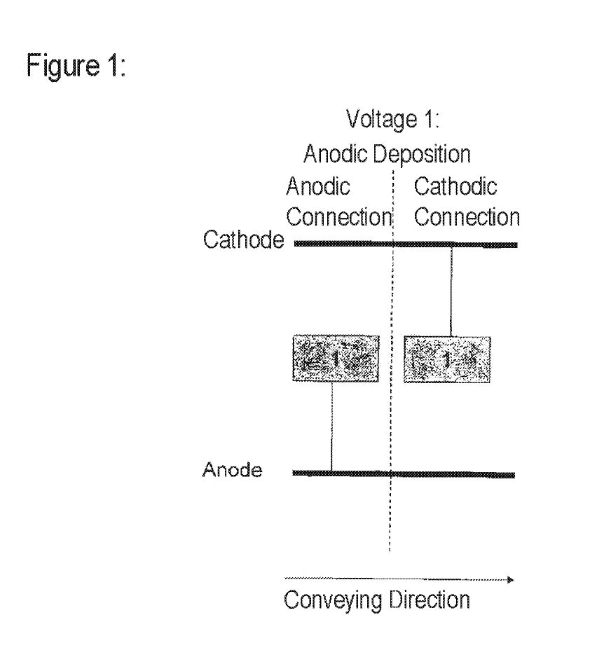

In one particular embodiment of the process of the invention, the counterelectrode (cathode) used to the anodically connected substrate is the substrate already anodically coated in the preceding coating stage. In other words, any substrate anodically connected beforehand, in the first stage, and hence anodically coated, may not only be connected as cathode in the subsequent stage for the purpose of cathodic coating, but may also serve, at the same time, as the counterelectrode for a further anodically connected first-stage substrate to be coated. FIG. 1 shows a corresponding procedure. As can be inferred from FIG. 1, when an electrically conductive substrate has been coated in the first stage of the process of the invention, an uncoated substrate to be coated anodically moves up into the dip-coating bath, and is connected as anode. The now anodically coated substrate connected beforehand as anode is given a change of polarity, to the cathode, for deposition of the principal binder, and serves at the same time as a counterelectrode for the substrate still to be coated anodically. The applied voltage is identical for both coating stages.

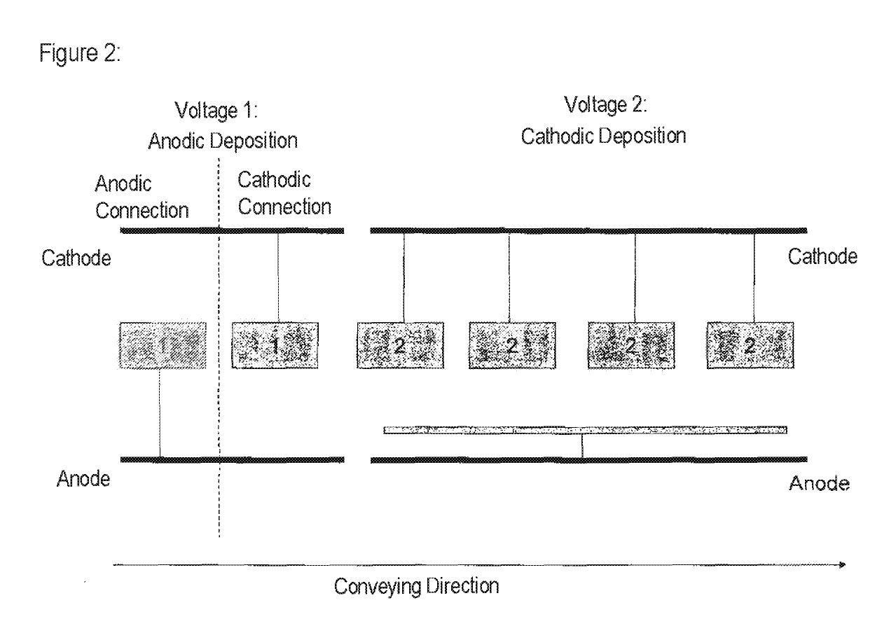

In one preferred variant of the aforementioned embodiment, a further cathodic deposition of the principal binder follows, at a higher voltage. Functioning as counterelectrode at this point are, for example, the anodes that are installed in conventional electrocoating baths. The embodiment of FIG. 1 that has this extra step is shown in FIG. 2. The voltage as part of the completion of cathodic deposition is preferably 50 to 500 volts, more preferably 250 to 400 volts.

Suitable electrically conductive substrates include in principle all electrically conductive materials, but especially metals such as, for example, iron, aluminum, magnesium, zinc, nickel, silver, copper, gold, platinum, and alloys of aforementioned metals, such as steel, for example. Preference is given to using steel, especially cold-rolled steel, galvanized steel, alloy-galvanized steel, aluminized steel, aluminum and its alloys, and magnesium and its alloys. In one especially preferred embodiment the electrically conductive substrate is aluminum. Where aluminum is the substrate selected, there is not only anodic deposition of the metal compounds from the dip-coating bath but also anodic oxidation of the aluminum surface, associated with an additional improvement in the corrosion resistance of the substrate.

Depending on the cleanliness of the substrates available, it may be advantageous to subject the substrate to one or more cleaning steps before the process of the invention is implemented. Particularly suitable for cleaning metal substrates such as steel, galvanized steels, and aluminum, for example, are liquid alkaline cleaners, preferably based on potassium hydroxide, optionally including borates and/or phosphates, which can be used in dipping or spraying procedures and which develop their activity particularly well in conjunction with liquid degreasing boosters based on ionic and nonionic surfactants. Corresponding cleaners and degreasing boosters are available for example under the brand names Ridoline® and Ridosol® for various substrates from Henkel AG & Co. KGaA.

The abovementioned substrates may be untreated, meaning that they have not been precoated or pretreated. Pretreated substrates which may be used include, for example, phosphatized substrates or substrates coated with modern thin-film methods. The method of the invention, though, removes the need for the phosphatizing pretreatment customary in automaking, in other words the deposition of a crystalline metal phosphate coat prior to cathodic electrocoating. For the purposes of the method of the invention, therefore, it is preferred for the electrically conductive substrate to have no crystalline metal phosphate layer at least on part of its surface, as for example on at least 10%, preferably at least 50%, more preferably at least 90%, and very preferably 100% of its surface. The corresponding phosphatizing step, including the customary accompanying activation and repassivation, can therefore be bypassed. The method, though, can also be applied to metal substrates which in part do have such a phosphate coat. Such metal substrates are formed, for example, by some of the metal panels used when assembling an automobile body already carry a crystalline metal phosphate coat. Such panels are referred to in vehicle construction as “prephosphatized”. Components of these kinds can of course likewise be used in the method of the invention.

The coating material composition present in the dip-coating bath is also referred to herein as electrocoat material.

The electrocoat materials which can be used in the method of the invention are aqueous coating material compositions which as well as a cathodically depositable, self-crosslinking or externally crosslinking principal binder include an anodically depositable component as defined above, comprising at least one anion of a phosphorus oxoacid, and further customary constituents such as neutralizing agents, solvents, pigments, additives such as wetting agents, flow control agents, biocides, or crosslinking catalysts, for example, and, in the case of the externally crosslinking principal binders, crosslinkers as well, such as blocked polyisocyanate, amino resins, phenolic resins, polyfunctional Mannich bases, melamine resins, benzoguanamine resins, epoxides and/or free polyisocyanates, for example. Preferred principal binders are externally crosslinking binders, and preferred crosslinkers are masked polyisocyanates. Particularly suitable masking agents are 2-ethylhexanol and 2-butanone oxime.

Principal binders used in the cathodic electrocoat materials of the present invention are, in particular, amine-modified principal binders, such as amine-modified epoxy resins, more particularly amine-modified aromatic epoxy resins, or amine-modified acrylate resins. Preferred, however, are the aforementioned amine-modified aromatic epoxy resins. Amine modification herein means that the epoxy resins contain protonated primary, secondary, or tertiary amino groups. In place of or in addition to the amine modification, however, there may also be modification with sulfonium groups or phosphonium groups; quaternary ammonium groups as well can be used.

The anodically depositable components, particularly the anions of the phosphorus oxoacids, have already been described in detail above and are used in the concentrations specified above. They may be employed in the form of their water-soluble salts, as ammonium salts or alkali metal salts, for example, but more particularly in the form of their water-soluble acidic salts or in the form of the parent acids to the anions. Where the anions are introduced in the form of the corresponding acids into the electrocoat materials, they may also serve in part for preliminary setting of the customary pH levels and/or for partial neutralization of the binders. In one preferred embodiment they are used during the actual preparation of the binder emulsion.

The ammonium, sulfonium and/or phosphonium groups of the principal binder are typically neutralized at least partly using water-soluble organic or inorganic acids such as, for example, lactic acid, formic acid, acetic acid, methanesulfonic acid, and the like. If the neutralizing agents meet the requirements for the anodically depositable component of the method of the invention, they are regarded as, and counted among, anodically depositable components for the purposes of the invention.

Besides the inorganic principle solvent, viz. water, the electrocoat materials typically also comprise small amounts of organic solvents. Solvents serve on the one hand for viscosity control and on the other hand for controlling the thickness of the coating film to be deposited. Hydrophilic solvents are commonly used, especially glycols such as ethyl glycol, butyl glycol, or hexyl glycol.

Pigments or fillers are commonly a further constituent of the electrocoat materials. The pigments or fillers may be selected such that they may also serve as an anodically depositable component. If, therefore, the aforementioned pigments or fillers meet the requirements for the anodically depositable component of the method of the invention, they are considered as, and counted among, anodically depositable components for the purposes of the invention.

Further constituents of the electrocoat materials that can be employed in accordance with the invention may include additives. Use is made in particular of surface-active agents—as wetting agents, defoamers, or flow control agents. Of these, the products with a nonionic activity are preferred, since they do not impair the deposition characteristics. Substances with bactericidal or fungicidal activity are used as well, in order to extend the life of the electrocoating baths. The crosslinking reaction between the principal binder and the crosslinker is normally catalyzed. If the aforementioned further constituents, especially the catalysts, meet the requirements for the anodically depositable component of the method of the invention, they are regarded as, and counted among, anodically depositable components for the purposes of the invention.

The cathodic electrocoat materials preferably employed in the present invention preferably possess a solid content of 10 to 30 wt %, more preferably 15 to 25 wt %, and very preferably 18 to 22 wt %. The solids content is the nonvolatile fraction of the electrocoat material, after drying of the dip-coating material at 130° C. for 60 minutes. Independently of this, the preferred pH of the electrocoat material is 4 to 7, more preferably 5 to 6.5, and very preferably 5 to 6.

In a further preferred embodiment of the method of the invention, the at least two-stage coating in a single dip-coating bath is followed by an additional rinsing step with water, preferably fully demineralized water, and subsequently, or instead, with an aqueous solution of a water-soluble catalyst that catalyzes the crosslinking reaction of the binders in the electrocoat material. This or these rinsing step or steps may be carried out as spray rinse steps or as dip rinse steps. Particularly when using an aqueous solution of a water-soluble catalyst that catalyzes the crosslinking reaction of the binders in the electrocoat material, the rinsing step is performed preferably as a dip rinse step. In the text below, the rinsing step with said crosslinking catalyst is also referred to as a catalyst rinse step or, in one preferred embodiment, as a catalyst dip-rinse step.

The catalyst rinse step is especially advantageous when the crosslinkable binders in the electrocoat material crosslink by catalysts which suffer loss of activity in the presence of the anions of the phosphorus oxoacids—for example, which form complexes or compounds of reduced activity and low solubility with the anions of the phosphorus oxoacids. It is possible in such a case, through the catalyst rinse step, after the electrocoating step of the invention has been carried out, to bring a crosslinking catalyst into subsequent contact with the electrocoat film. After the electrocoat material has been applied in accordance with the invention, in the at least two-stage method of the invention, the coagulated electrocoat film is depleted in the anions of the phosphorus oxoacids, and so contacting the electrocoat film subsequently with catalysts in a catalyst rinse step reduces the risk of deactivation of the catalyst subsequently introduced. In this way it is even possible in certain cases not to add any crosslinking catalyst for the crosslinking of the binders in the electrocoating bath to that bath, and to apply such catalysts only subsequently, through the catalyst rinse step, into the electrocoat film that has already been applied. It is possible, though not mandatory, to do without a crosslinking catalyst in the electrocoating bath. In one particular embodiment, therefore, the electrocoating bath contains no crosslinking catalyst for the crosslinking of the binders present therein. Even in such cases it is possible to obtain fully crosslinked electrocoat systems.

Typical crosslinking catalysts which may be applied in the catalyst rinse step are metal-containing catalysts comprising compounds of tin and/or of bismuth. Suitable in this context are all compounds of tin and/or of bismuth which have at least partial water solubility and which catalyze the crosslinking reaction. Especially preferred as catalysts are water-soluble salts of bismuth such as bismuth nitrate, bismuth lactate, bismuth methylolpropionate, or bismuth methanesulfonate, for example, and also water-soluble complexes of bismuth such as bismuth-EDTA and bismuth-bicine, for example.

The catalyst rinse step is preferably conducted as a dip-rinse step, the immersion time being preferably 10 to 500, more preferably 15 to 300, and very preferably 30 to 120 seconds. Immersion times of more than 500 seconds typically lead to no perceptible improvements, while lowering the immersion time to below 10 seconds is in certain cases not enough to introduce a sufficient quantity of catalyst into the coagulated electrocoat film. The temperature of the catalyst rinse solution is preferably 15 to 60, more preferably 30 to 50° C.

The concentration range for the metal-containing catalyst in the catalyst rinse solution, more particularly catalyst dip-rinse solution, is preferably 10 to 20 000, more preferably 50 to 10 000, and very preferably 100 to 5000 ppm.

The substrate provided with the electrocoat film may also be connected as cathode during the catalyst rinse step, for further improvement in the subsequent crosslinking, in order to introduce metal cations, acting as crosslinking catalysts, into the electrocoat film applied beforehand in accordance with the invention. A further-improved crosslinking also has the effect of significantly enhanced solvent resistance, with positive consequences for the typical aftercoating steps with, in particular, solventborne surfacers, basecoat materials, and clearcoat materials.

The time during which the substrate dip-coated in accordance with the invention is connected as cathode in the catalyst rinse solution is situated preferably in the range from 10 to 500 seconds, more particularly in the range from 15 to 300 seconds, and very preferably in the range from 30 to 120 seconds. The rule of thumb here is that the lower the voltage applied, the longer the period that must be selected. If the catalyst rinse step is carried out with application of a voltage and with connection of the substrate as cathode, then the applied voltage is typically in the range from 5 to 100 V, preferably 5 to 50 V.

Following the application of the electrocoat film, with or without catalyst rinse step, the electrocoat film is cured preferably at temperatures >80° C., more preferably at temperatures >120° C., and very preferably at temperatures of 150 to 190° C., for a time of preferably 10 to 30 minutes.

Because the coated substrates obtained by the method of the invention have a uniform, virtually continuous inorganic coat, formed from the anodically depositable components, and possess a separate cathodically deposited coating film, the coated substrates as well are new in relation to the coated substrates known hitherto.

A further subject of the present invention, therefore, is a substrate coated by the method of the invention. The coated substrate is preferably a vehicle body or part of a vehicle body, and more particularly is an automobile body or part thereof.

The coated substrates obtained by the method of the invention, by virtue of the coating, have outstanding corrosion resistance, and the coating can be classed as very good in terms of its properties of adhesion to the substrate. The application of further coats to the substrate coated in accordance with the invention also leads to outstanding results in terms of corrosion resistance and adhesion properties in relation to the overall multicoat paint system.

The invention is described in more detail below using working examples.

### EXAMPLES

### Methods of Determination

### 1. Copper-Accelerated Acetic Acid Salt Spray Mist Test to DIN EN ISO 9227 CASS (for Short: CASS Test)

The copper-accelerated acetic acid salt spray mist test serves for determining the corrosion resistance of a coating on a substrate. The copper-accelerated acetic acid salt spray mist test is carried out according to DIN EN ISO 9227 CASS for the metallic aluminum substrate (AA6014 (ALU)) coated by the method of the invention or by a comparative method. It involves the samples under investigation being in a chamber in which misting is performed continuously over a duration of 240 hours and at a temperature of 50° C. with a 5% strength common salt solution of controlled pH, with copper chloride and acetic acid being added to the salt solution. The mist is deposited on the samples under investigation, coating them with a corrosive salt water film.

Prior to the copper-accelerated acetic acid salt spray mist test to DIN EN ISO 9227 CASS, the samples under investigation are scored down to the substrate with a knife cut, allowing the samples to be investigated for their degree of corrosive undermining in accordance with DIN EN ISO 4628-8, since during the copper-accelerated acetic acid salt spray mist test to DIN EN ISO 9227 CASS, the substrate is corroded along the line of scoring. The progressive process of corrosion causes greater or lesser undermining of the coating in the course of the test. The degree of undermining in [mm] is a measure of the resistance of the coating.

### 2. Filiform Corrosion to DIN EN 3665 (for Short: Filiform Test)

Determining the filiform corrosion is used to ascertain the corrosion resistance of a coating on a substrate. This determination is carried out according to DIN EN 3665 (date: Aug. 1, 1997) for the electrically conductive substrate aluminum (ALU), coated with an inventive coating composition or with a comparative coating composition, over a duration of 1008 hours. In the test, the respective coating, starting from a line of induced damage to the coating, is undermined by corrosion that takes the form of a line or thread. The average and maximum thread lengths in [mm] can be measured according to DIN EN 3665 (Method 3), and are a measure of the resistance of the coating to corrosion. Also determined is the undermining in [mm] according to PAPP WT 3102 (Daimler) (date: Dec. 21, 2006).

### 3. VDA Alternating Climate Test to VDA 621-415 (for Short: ACT-VDA) [VDA=German Automakers Association]

This alternating climate test is used for determining the corrosion resistance of a coating on a substrate. The alternating climate test is carried out for the correspondingly coated cold-rolled steel (CRS) substrate. The alternating climate test is carried out in 10 cycles. One cycle consists of a total of 168 hours (1 week) and encompasses
a) 24 hours of salt spray mist testing to DIN EN ISO 9227 NSS (date: Sep. 1, 2012),
b) followed by 8 hours of storage, including warming, as per DIN EN ISO 6270-2 of September 2005, AHT method,
c) followed by 16 hours of storage, including cooling, as per DIN EN ISO 6270-2 of September 2005, AHT method,
d) 3-fold repetition of b) and c) (hence in total 72 hours), and
e) 48 hours of storage, including cooling, with an aerated climate chamber as per DIN EN ISO 6270-2 of September 2005, AHT method.

If, still prior to the alternating climate test being carried out, the respective baked coating of the samples under investigation is scored down to the substrate with a knife cut, the samples can be investigated for their degree of corrosive undermining according to DIN EN ISO 4628-8 (date: Mar. 1, 2013), since the substrate is corroded along the scoring line during the implementation of the alternating climate test. The progressive process of corrosion causes greater or lesser undermining of the coating during the test. The degree of undermining in [mm] is a measure of the resistance of the coating.

### 4. VW Alternating Climate Test, PV 1210 (for Short: ACT-VW)

This alternating climate test is used to ascertain the corrosion resistance of a coating on a substrate. The alternating climate test is carried out for the electrically conductive cold-rolled steel (CRS) substrate, coated by the method of the invention or by a comparative method. This alternating climate test is carried out in 30 cycles. One cycle (24 hours) consists of 4 hours of salt spray mist testing to DIN EN ISO 9227 NSS (date: Sep. 1, 2012), 4 hours of storage, including cooling, according to DIN EN ISO 6270-2 of September 2005 (AHT method), and 16 hours of storage, including warming, according to DIN EN ISO 6270-2 of September 2005, AHT method, at 40±3° C. and a humidity of 100%. After every 5 cycles there is a pause of 48 hours, including cooling, according to DIN EN ISO 6270-2 of September 2005, AHT method. 30 cycles therefore correspond to a duration of 42 days in all.

If, still prior to the alternating climate test being carried out, the coating of the samples under investigation is scored down to the substrate with a knife cut, the samples can be investigated for their degree of corrosive undermining according to DIN EN ISO 4628-8 (date: Mar. 1, 2013), since the substrate is corroded along the scoring line during the implementation of the alternating climate test. The progressive process of corrosion causes greater or lesser undermining of the coating during the test. The degree of undermining in [mm] is a measure of the resistance of the coating.

After the alternating climate test has been carried out, the samples can be investigated for their degree of blistering in accordance with DIN EN ISO 4628-2 (date: Jan. 1, 2004). The assessment is made using characteristic values in the range from 0 (low degree of blistering) to 5 (very high degree of blistering).

### 5. X-Ray Fluorescence Analysis (XFA) for Film Weight Determination

The anodic deposition of the anions of the oxoacid of phosphorus is determined by means of wavelength-dispersive X-ray fluorescence analysis (XFA) according to DIN 51001 (date: August 2003). The signals obtained during the implementation of the X-ray fluorescence analysis are corrected to account for a separately measured substrate of an uncoated reference sample. Gross count rates (in kilocounts per second) are determined for each of the elements under analysis (presently: phosphorus). The gross count rates for phosphorus from a reference sample (uncoated substrate) are subtracted from the thus-determined gross count rates for the respective sample, to give the net count rates of the elements under analysis.

### 6. Solvent Resistance Test (for Short: SR Test)

The solvent resistance of the baked electrocoats was ascertained by means of an acetone test. In this test, a cloth soaked with acetone was rubbed over the coating, this being recorded in the form of double rubs (back and forth). The double rub values reported indicate the number of double rubs necessary to expose the metallic substrate beneath the coating. This analysis was carried out only up to a maximum of 50 double rubs; a report of 50 double rubs means that the coating is solvent-resistant for the purposes of this test.

### Electrocoat CG 520

The electrocoat material identified below as electrocoat CG 520 is obtained by mixing 4840 g of fully demineralized water, 4590 g of the binder CG 520 (manufacturer: BASF Coatings GmbH; solids content: 40%), and 630 g of pigment paste CG 520 (manufacturer: BASF Coatings GmbH; solids content: 65%) with one another with stirring. The conditions of cathodic deposition with this electrocoat material and with the electrocoat materials produced therefrom and used in accordance with the invention were typically 32° C. for a duration of 120 seconds, unless otherwise indicated. Unless otherwise indicated, the voltage was set in the range from 160 V to 240 V so as to give a dry film thickness, for the baked coating material, of 20 μm.

### In-House Binder Dispersion D1

A crosslinking agent V1 was prepared as described in DE 102007038824, paragraph [0028] in example 1.1.

An aqueous binder dispersion D1 was prepared as described in DE 102007038824, paragraphs [0029 to 0030] in example 1.2.

The subsequent workstep in paragraph [0031] was modified as follows:

2400 parts of the resulting mixture are dispersed immediately into an existing mixture of 2173 parts of demineralized water and 25.7 parts of glacial acetic acid. Addition of a further 751 parts of demineralized water gives a stable dispersion.

### In-House Pigment Paste

The pigment paste was prepared by the method described in DE 10 2008 016220 A1 (page 7, Table 1, variant B).

### Examples 1a to 1f

### Deposition from Aqueous Solutions

Sheets of cold-rolled steel (CRS sheets), available under the Gardobond MBS designation from Chemetall, were first subjected to dip cleaning in a solution of Ridoline 1565 (3%) and Ridosol 1400 (0.3%), according to the use instructions, for 5 minutes at 60° C. (Ridoline 1565 and Ridosol 1400 are available from Henkel). This was followed by dip rinsing with service water (1 min) and then with fully demineralized water (1 min).

After this cleaning, the cold-rolled steel sheets were treated under various conditions (see Table 1) anodically for 30 seconds with an acetate-buffered (5 g/l acetate buffer pH 5.2), aqueous solution of sodium dihydrogen phosphate (0.9 g/l) in a dip-coating bath.

Thereafter the sheets were rinsed for 1 minute by spraying with fully demineralized water, followed by drying.

The deposition of phosphorus was evaluated by XFA (X-ray fluorescence analysis). The phosphorus add-on was determined from the intensity of the phosphorus signal in kilocounts per second (kcps) (higher values correspond to a higher deposition rate). The results are presented in Table 1.

TABLE 1

| | | Phosphorus |
|---|---|---|
| Example | Dipping conditions | add-on in kcps |
| 1a | electroless | 3.76 |
| 1b | 20 V (continuous) | 17.15 |
| 1c | 30 V (continuous) | 17.7 |
| 1d | 10 V (pulse method: 1 sec on, | 8.45 |
| | 0.1 sec off) | |
| 1e | 20 V (pulse method: 1 sec on, | 11.6 |
| | 0.1 sec off) | |
| 1f | 20 V (pulse method: 2 sec on, | 19.03 |
| | 0.1 sec off) | |

The investigations show that when an anodic current was used, the deposition of phosphorus found on the metal sheet was higher by comparison to electroless immersion into the solution.

### Examples 2a to 2e

### Deposition from Electrocoat-Containing Baths

Sheets of cold-rolled steel (CRS sheets), available under the Gardobond MBS designation from Chemetall, were first subjected to dip cleaning in a solution of Ridoline 1565 (3%) and Ridosol 1400 (0.3%), according to the use instructions, for 5 minutes at 60° C. This was followed by dip rinsing with service water (1 min) and then with fully demineralized water (1 min).

After this cleaning, the cold-rolled steel sheets were coated under different inventive conditions (see Table 2), first anodically and then cathodically with a standard-use cathodic electrocoat material (CG 520, BASF Coatings GmbH) to which 0.9 g/l sodium dihydrogen phosphate was added.

Thereafter the sheets were rinsed for 1 minute by spraying with fully demineralized water, followed by drying, and then baked in a forced air oven at 175° C. for 25 minutes (corresponding to a hold time of around 15 minutes at a substrate temperature of 175° C.).

The deposition of phosphorus was evaluated by XFA (X-ray fluorescence analysis). The phosphorus add-on was determined from the intensity of the phosphorus signal in kilocounts per second (kcps) (higher values correspond to a higher deposition rate). The results are presented in Table 2.

TABLE 2

| | | Phosphorus |
|---|---|---|
| Example | Dipping conditions | add-on in kcps |
| 2a | Anode: 30 sec at 5 V | 9.16 |
| | Cathode: 120 sec at 200 V | |
| 2b | Anode: 30 sec at 15 V | 9.92 |
| | Cathode: 120 sec at 200 V | |
| 2c | Anode: 30 sec at 30 V | 9.83 |
| | Cathode: 120 sec at 200 V | |
| 2d | Anode: 60 sec at 30 V | 10.26 |
| | Cathode: 120 sec at 200 V | |
| 2e | Anode: 120 sec at 30 V | 10.97 |
| | Cathode: 120 sec at 200 V | |

The investigations show that an increase in the coating time in the anodic stage leads to an increase in the amount of phosphorus deposited.

### Example 3a (Noninventive), 3b (Inventive), 3c (Inventive), and 3d (Inventive)

### Effect of Phosphorus Deposition on Corrosion Control

Sheets of cold-rolled steel (CRS sheets), available under the Gardobond MBS designation, and also sheets of hot-dip galvanized steel (HDG sheets), available under the Gardobond EA designation, and sheets of aluminum, available under the Gardobond Aluminium AA6014 designation, all Gardobond sheets from Chemetall, were first subjected to dip cleaning in a solution of Ridoline 1565 (3%) and Ridosol 1400 (0.3%), according to the use instructions, for 5 minutes at 60° C. This was followed by dip rinsing with service water (1 min) and then with fully demineralized water (1 min).

The sheets thus cleaned were coated under different inventive conditions (see Table 3), first anodically and then cathodically. In the case of noninventive example 3a, a standard-use cathodic electrocoat material (CG 520, available from BASF Coatings GmbH) was used. In inventive examples 3b and 3c, the samples were likewise coated with the electrocoat material CG 520, to which different amounts (0.3 or 0.9 g/l) of sodium dihydrogen phosphate (examples 3b and 3c) were added. In inventive example 3d, the electrocoat material was prepared by replacing the CG520 binder component with equal parts of dispersion D1. This electrocoating bath was admixed with 1.82 g/l 95% strength orthophosphoric acid.

Thereafter the sheets were rinsed by spraying with fully demineralized water for 1 minute, followed by drying, and were baked in a forced air oven at 175° C. for 25 minutes (corresponding to a hold time of about 15 minutes at a substrate temperature of 175° C.).

TABLE 3

| | | Phosphorus |
|---|---|---|
| | | compound and |
| Example | Dipping conditions | concentration |
| 3a | Anode: no anodic deposition | — |
| | Cathode: 120 sec at 220 V | |
| 3b | Anode: 30 sec at 20 V | NaH₂PO₄ |
| | Cathode: 120 sec at 220 V | 0.3 g/l |
| 3c | Anode: 30 sec at 20 V | NaH₂PO₄ |
| | Cathode: 120 sec at 220 V | 0.9 g/l |
| 3d | Anode: 30 sec at 20 V | H₃PO₄ |
| | Cathode: 120 sec at 220 V | 1.82 g/l |

Table 4 reports the performance results in the corrosion tests described above. The example number has been given a suffix code for the substrate used: CRS, HDG, or ALU.

TABLE 4

| | | Filiform test | Filiform test | | |
|---|---|---|---|---|---|
| | CASS | undermining | thread length | ACT- | ACT- |
| Example | test | (max.) | (max.) | VDA | VW |
| 3a-CRS | — | — | — | 11.2 | 9.1 |
| 3b-CRS | — | — | — | 6.8 | 9.4 |
| 3c-CRS | — | — | — | 8.0 | 7.8 |
| 3d-CRS | — | — | — | — | 3.9 |
| 3a-HDG | — | — | — | — | 5.2 |
| 3b-HDG | — | — | — | — | 5.2 |
| 3c-HDG | — | — | — | — | 5.8 |
| 3d-HDG | — | — | — | — | 2.2 |
| 3a-ALU | 2.5 | 3.1 | 8.0 | — | — |
| 3b-ALU | 1.7 | 0.3 | 1.6 | — | — |
| 3c-ALU | 0.9 | 0.1 | 1.2 | — | — |
| 3d-ALU | 1.2 | — | — | — | — |

In virtually all cases on all substrates, the results show a distinct improvement in corrosion control relative to noninventive example 3a. In this case there is generally likewise an increase in corrosion control with increasing phosphate content on the part of the electrocoat material. For example 3d (highest phosphate content), it was found, in a filtration experiment not presented above, that the long-term bath stability was somewhat lower than for the other inventive electrocoat materials. This means that phosphate contents beyond that selected in example 3d may have an adverse effect on bath stability.

### Examples 4a (Noninventive), 4b (Inventive), 4c (Inventive), 4d (Inventive), and 4e (Inventive)

### Effect of a Bismuth Catalyst Rinse (Electroless)

Noninventive example 4a corresponds to noninventive example 3a. Inventive example 4b corresponds to inventive example 3d. Inventive examples 4c, 4d, and 4e differ from example 4b only in that immediately after the spray rinse with fully demineralized water and before implementation of the 175° C. baking step, a further rinsing step was carried out electroless with a rinsing solution containing bismuth ions for 1 minute (example 4c), 2 minutes (example 4d), or 3 minutes (example 4e). The dip rinsing solution containing bismuth ions that was used was a solution, regulated to a temperature of 30° C., of 23.3 g of bismuth methane sulfonate in 2.2 l of fully demineralized water, this solution having been adjusted to a pH of 4.3 using ammonium hydroxide solution.

As well as corrosion control tests, a determination was also made of the solvent resistance of the baked electrocoat materials obtained. The results of the corrosion control tests and of the solvent resistance test have been reproduced in Table 5.

TABLE 5

| | CASS | ACT- | SR |
|---|---|---|---|
| Example | test | VW | test |
| 4a-CRS | — | 9.1 | 50 |
| 4b-CRS | — | 3.9 | 4 |
| 4c-CRS | — | 4.1 | 8 |
| 4d-CRS | — | 5.0 | 10 |
| 4e-CRS | — | 5.2 | 50 |
| 4a-HDG | — | 5.2 | 50 |
| 4b-HDG | — | 2.2 | 5 |
| 4c-HDG | — | 2.1 | 6 |
| 4d-HDG | — | 3.1 | 46 |
| 4e-HDG | — | 2.3 | 49 |
| 4a-ALU | 2.5 | — | 50 |
| 4b-ALU | 1.2 | — | 6 |
| 4c-ALU | 1.6 | — | 45 |
| 4d-ALU | 1.5 | — | 30 |
| 4e-ALU | 1.2 | — | 22 |

In all cases on all substrates, the results show a distinct improvement in corrosion control relative to noninventive example 4a. As the period of immersion goes up, there is a marked increase in the solvent resistance of the baked cathodic electrocoats on cold-rolled steel and hot-dipped galvanized steel.

### Inventive Examples 5a to 5f: Effect of Bismuth Catalyst Rinsing, with Cathodic Current Applied

In example 4 it was shown that the use of a bismuth rinse allows the degree of crosslinking or solvent resistance of a cathodic electrocoat system to be increased. In this example, additionally, a cathodic current was applied to the substrate during this rinsing step. It was shown that the cathodic current allows the effect of the bismuth rinse to be increased, and that the application of the cathodic current allows the immersion time to be reduced (see Table 6).

Inventive example 5a corresponds to inventive example 4c (1-minute electroless after-rinsing). Examples 5b, 5c, and 5d differ from example 5a only in the application of a voltage of 5V (example 5b), 10V (example 5c), and 30V (example 5d) and hence in a cathodic deposition of bismuth during the immersion time of 1 minute. Example 5e differs from example 5a in an increased immersion time of 3 minutes and in the application of a voltage of 30V, while in example 5f (by comparison with example 5e) the immersion time was increased again to 5 minutes.

TABLE 6

| Example | SR test |
|---|---|
| 5a-CRS | 8 |
| 5b-CRS | 29 |
| 5c-CRS | 15 |
| 5d-CRS | 50 |
| 5e-CRS | 50 |
| 5f-CRS | 50 |
| 5a-HDG | 6 |
| 5b-HDG | 49 |
| 5c-HDG | 30 |
| 5d-HDG | 30 |
| 5e-HDG | 50 |
| 5f-HDG | 50 |
| 5a-ALU | 45 |
| 5b-ALU | 50 |
| 5c-ALU | 50 |
| 5d-ALU | 50 |
| 5e-ALU | 47 |
| 5f-ALU | 50 |

1: A process for an at least two-stage coating of an electrically conductive substrate, the process comprising: in a single dip-coating bath comprising a coating material composition which comprises at least one cathodically depositable film-forming polymer and an anodically depositable component comprising anions of at least one phosphorus oxoacid,
connecting the electrically conductive substrate for coating as an anode in a first stage to obtain a precoated substrate, and
connecting the precoated substrate as cathode in a subsequent stage.

2: The process as claimed in claim 1, wherein the anions of the phosphorus oxoacid are anions of phosphoric acid, anions of phosphorous acid, anions of diphosphoric acid, anions of diphosphorous acid, anions of linear or cyclic oligophosphoric acids having 3 to 10 phosphorus atoms, or any mixtures thereof.

3: The process as claimed in claim 1, wherein the anions of the at least one phosphorus oxoaxid are present in a concentration of 0.1 to 40 g/l in the coating material composition of the dip-coating bath.

4: The process as claimed in claim 1, wherein a voltage in the range from 1 to 100 volts is applied in the first stage between the electrically conductive substrate connected as anode and a counterelectrode.

5: The process as claimed in claim 1, wherein the electrically conductive substrate in the first stage is connected as anode for a period in the range from 5 to 240 seconds.

6: The process as claimed in claim 4, wherein the counterelectrode constitutes an electrically conductive substrate which in a preceding stage was connected as anode in the dip-coating bath.

7: The process as claimed in claim 1, wherein the electrically conductive substrate connected as anode in the first stage is connected as cathode in the subsequent stage in the dip-coating bath, relative to an anode with a voltage in the range from 50 to 500 volts applied between the electrically conductive substrate and the anode.

8: The process as claimed in claim 7, wherein the voltage between the electrically conductive substrate connected as cathode and the anode is maintained for a period of 10 to 300 seconds at a level within the stated voltage range.

9: The process as claimed in claim 1, wherein the electrically conductive substrate last connected as cathode is withdrawn from the dip-coating bath and, with or without intermediate rinsing with water, is contacted with an aqueous solution of a crosslinking catalyst for a reaction between epoxy resins and/or acrylate resins with crosslinking agent selected from the group consisting of a blocked polyisocyanate, an amino resin, a phenolic resin, a polyfunctional Mannich base, a melamine resin a benzoguanamine resin, an epoxide, a free polyisocyanate, and a mixture thereof.

10: The process as claimed in claim 9, wherein the aqueous solution of a crosslinking catalyst is a solution of a water-soluble bismuth compound.

11: The process as claimed in claim 9, wherein a cathodic voltage is applied relative to an anode to the electrically conductive substrate during contact with the aqueous solution of the crosslinking catalyst.

12: The process as claimed in claim 1, wherein the voltage is 5 V to 100 V.

13: The process as claimed in claim 1, wherein the electrically conductive substrate has no crystalline metal phosphate layer at least on part of its surface.

14: The process as claimed in claim 1, wherein the substrate is a vehicle body or a part of the vehicle body.

15: The process as claimed in claim 1, wherein a resulting electrocoat film is cured at a temperature of >80° C.

16: A substrate coated by the process as claimed in claim 1.

17: The substrate as claimed in claim 16, coated additionally with at least one surfacer and/or at least one basecoat material and/or at least one clearcoat material, wherein the coats applied are cured individually or jointly.

18: The substrate as claimed in claim 16, which is a vehicle body or a part of the vehicle body.
